(19) United States
(12) Patent Application Publication
(10) Pub. No.: US 2007/0094935 A1
(43) Pub. Date: May 3, 2007

(54) Reversible steel-reinforced door

(75) Inventor: Roberto Molinari, Piacenza (IT) (IT)

Correspondence Address: YOUNG & THOMPSON, 745 SOUTH 23RD STREET, 2ND FLOOR, ARLINGTON, VA, 22202, US

(73) Assignee: MASTER COSTRUZIONI TECNICHE DI SICUREZZA S.R.L., PIACENZA (PC) (IT)

(21) Appl. No.: 11/545,522

(22) Filed: Oct. 11, 2006

(30) Foreign Application Priority Data
Oct. 31, 2005 (IT) PC 2005 U 000031

(51) Int. Cl. E06B 3/00

(52) U.S. Cl. 49/503

(57) ABSTRACT

A steel-reinforced door including a sheet metal framework, strengthened with a plurality of metal structural sections, to which a lock and bolts are fitted, the metal sheet also acting as support for a plurality of mechanisms designed for the operation of the bolts, the steel-reinforced door being mounted on a frame via hinges, and closing due to the effect of the bolts which engage with holes made in the frame. The door includes a first element designed to allow the door to be opened either inwards or outwards, maintaining its function as a steel-reinforced door, the first element including a second metal sheet (10), connected to the sheet metal framework (4) so as to form, with the framework (4), a closed structure suitable to house the lock (8) and the bolts (9, 9a), and the mechanisms designed to operate the bolts (9, 9a).

This invention relates to a steel-reinforced door suitable for use with various types of opening, namely inwards or outwards, to right or left, with no need to change its structure.

According to the prior art, steel-reinforced doors consist of a sheet metal structure to which the hinges, lock, bolts, and all the mechanisms used to operate them, are fitted. The sheet metal structure is substantially constituted by a steel sheet to which a number of reinforcements, also made of sheet steel, are fitted, a number of currents being applied to the sheet steel to increase the flexural and torsional rigidity of the structure. The structure is then clad with wood panels which give it a more attractive appearance.

The metal sheet is basically positioned on the side of the door which faces outwards during assembly. In this way the lock and all the other internal mechanisms are protected, while a simple wooden panel is fitted to the other side.

To design a steel-reinforced door, it is therefore necessary to know which side is the outside, as simple rotation of the door so as to reverse the exterior and the interior would put the weaker side, consisting only of a wooden panel, on the outside.

This is a source of problems because it requires the manufacture of structures for steel-reinforced doors for specific needs. Said drawbacks affect both manufacturers of structures and joiners that specialise in cladding said structures with wooden panels of attractive appearance. In this case it is necessary to provide no less than four variations on the same type of structure, because these orders are usually placed before the clad doors have been ordered. This obviously means that a large amount of material has to be procured, which ties up a large amount of space and capital.

Said drawback is overcome by the present invention, which offers a structure for steel-reinforced doors, as claimed in claim 1, designed to be used for opening either inwards or outwards, to the right or the left, with no need to change the structure or the frame on which said structure is mounted.

The advantage resulting from the use of the structures according to the invention is that manufacture is standardised to a greater extent, and the number of said structures stocked is greatly reduced.

The invention will now be described in detail according to a preferred embodiment, by way of example but not of limitation, with reference to the annexed figures, wherein:

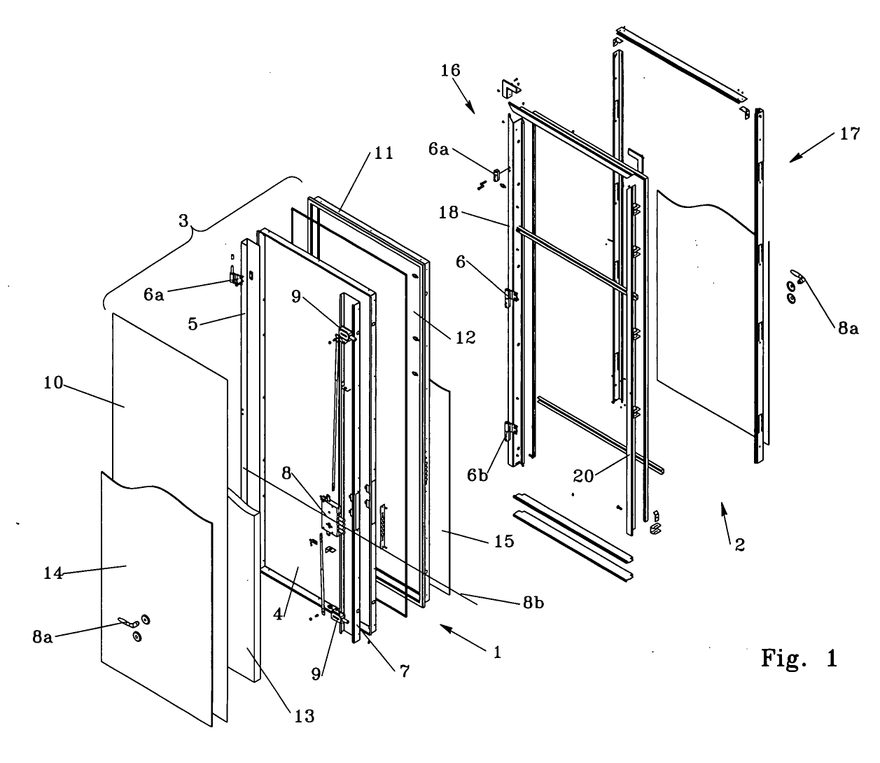

FIG. 1 shows an exploded drawing of a steel-reinforced door according to the invention;

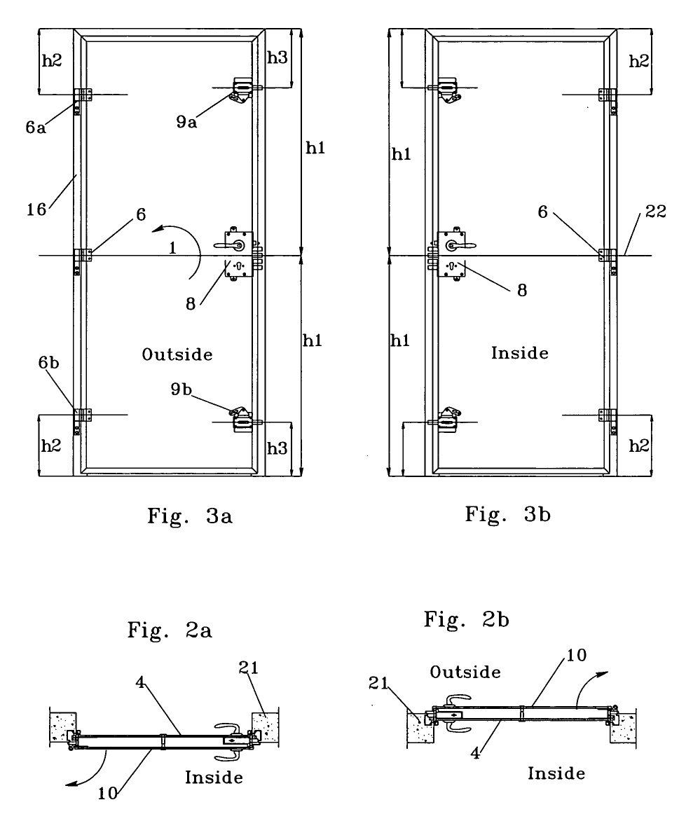

FIGS. 2 (a, b) show the door according to the invention designed to open either inwards or outwards;

FIGS. 3 (a, b) show the door according to the invention designed to open either to right or left.

FIG. 1 shows an exploded view of a door (1) according to the invention, with its frame (2). Door (1) comprises a structural part (3), consisting basically of a sheet metal framework (4), a first reinforcement (5) on the side of hinges (6, 6a, 6b), and a second reinforcement (7) on the side of lock (8) and bolts (9a, 9b), which said reinforcements (5) and (7), also made of sheet metal, are welded to framework (4). A pair of handles (8a) are fitted to lock (8), while lock (8) is fitted in such a way that the central bolt is exactly halfway up second reinforcement (7), namely on the horizontal axis (8b). Bolts (9) and (9a) and hinges (6, 6a, 6b) are also positioned symmetrically in relation to said axis (8b).

A panel (10), also made of sheet metal, is attached to framework (4) by spot welds. A surround (11), with the insertion of a seal (12), can advantageously be fitted on the side of framework (4).

As it is made of sheet metal, surround (11) is part of structure (3).

Thus a structure (3), closed on both sides, is formed, inside which said lock (8), with the various mechanisms for control of bolts (9), is inserted.

A rock wool panel (13) which increases the fire resistance and soundproofing of the door, can advantageously be inserted inside structure (3).

Structure (3) is clad in turn with wooden panels (14) and (15) to improve its appearance.

Frame (2) comprises a main frame (16) and a subframe (17), which is connected to frame (16) to enclose the door jamb.

Main frame (16) comprises a first upright (18), to which are fitted the fixed parts of hinges (6, 6a, 6b), and a second upright (20) containing the openings engaged by bolts (7) and lock (8).

Subframe (17) also consists of a number of assembled parts. As they are known to the prior art, frame (16) and subframe (17) will not be further described.

FIG. 2 shows door (1) according to the invention, mounted on a wall (21) via its frame (2). In FIG. 2a, door (1) opens inwards, rotating on hinges (6, 6a, 6b), whereas in FIG. 2b, door (1) opens outwards. For the sake of simplicity, door (1) and frame (2) are illustrated schematically in the drawing.

The two different configurations are obtained by rotating the door+frame assembly around a vertical axis, so that panel (10), which was originally inside wall (21) (FIG. 2a), is outside wall (21) after said rotation (FIG. 2b). Similarly, framework (4), which was originally outside wall (21) (FIG. 2a), is inside wall (21) after said rotation (FIG. 2b).

As will be seen from FIG. 2, door (1) according to the invention can be fitted to open either inwards or outwards, because the sheet metal panel is essential to protect lock (8) and the various internal mechanisms designed to control bolts (9, 9a) will always be on the outer side.

FIG. 3 (a, b) shows door (1) according to the invention fitted to a wall (21) via its frame (2). In both cases, door (1) opens on the same side; however, in the case shown in FIG. 3a, door (1) opens to the left, whereas in the case shown in FIG. 3b, door (1) opens to the right.

The two different configurations are obtained simply by rotating the door on its plane, as indicated by the arrow. As central bolt (8) is positioned exactly on the axis of horizontal symmetry (8b) of door (1), namely at a distance h₁ from both the lower and upper ends of said door, it will still be at the same height above ground after rotation. The same applies to the hinges. Hinge (6a), which was in the upper part, will be in the lower part after rotation, whereas hinge (6b), which was in the lower part, will be in the upper part after rotation, while hinge (6), which was exactly in the centre, will still be in the centre after rotation. As the distance of hinges (6a) and (6b) from the corresponding edge is h₂, they will still be at the same distance from the corresponding edge after rotation, and hinge (6) will still be in the centre.

This means that if the strike plates of lock (8) are fitted to both uprights (16) and (17) and the holes required for the passage of bolts (9, 9a) and the fitting of hinges (6, 6a, 6b) are drilled, the said frame (2) becomes suitable to receive door (1) in both configurations, in order to achieve opening to either the right or the left.

In practice, however, as this would mean making a large number of holes in frame (2), which would spoil its appearance; in the case of upmarket products, it is therefore preferable to make one frame for each opening direction.

If the same frame (2) is not used for right opening and left opening, there is obviously no need to comply with the condition of symmetry for hinges (6, 6a, 6b) and bolts (9, 9a), whereas it is appropriate for central bolt (8) to be fitted in any event on the axis of symmetry (8b), so as not to change the height of handle (8a) above ground after rotation.

As will appear clearly from the preceding description, the steel-reinforced door (1) according to the invention is perfectly able to adapt to any situation as regards opening side (inward or outward), or opening direction (right or left). This is particularly useful to reduce manufacturing costs, due to the greater standardisation of the product, and to reduce the number of parts stored. This latter advantage is particularly important for joiners specialising in door manufacture, as it greatly reduces stocks.

The invention has been described by way of example but not of limitation, according to a preferred form of embodiment. One skilled in the art could devise numerous other embodiments, all of which fall into the ambit of protection of the following claims.

1) Steel-reinforced door, of the type comprising a sheet metal framework, strengthened with a plurality of metal structural sections, to which a lock and bolts are fitted, said metal sheet also acting as support for a plurality of mechanisms designed for the operation of said bolts, said steel-reinforced door being mounted on a frame via hinges, and closing due to the effect of said bolts which engage with holes made in said frame, characterised in that it includes first means designed to allow the door to be opened either inwards or outwards, maintaining its function as a steel-reinforced door, said first means comprising a second metal sheet (10), connected to said sheet metal framework (4) so as to form, with said framework (4), a closed structure suitable to house said lock (8) and said bolts (9, 9a), and said mechanisms designed to operate said bolts (9, 9a).

2) Steel-reinforced door, as claimed in claim 1, characterised in that it also includes second means designed to allow the opening of said door (1) to the right or the left.

3) Steel-reinforced door, as claimed in claim 2, characterised in that said second means designed to allow the opening of said door (1) to the right or the left comprise connectors for a central bolt (8) fitted at the axis of horizontal symmetry (8b) of said door (1).

4) Steel-reinforced door, as claimed in claim 2, characterised in that said second means designed to allow the opening of said door (1) to right or left comprise said bolts (9, 9a) fitted symmetrically in relation to said axis of horizontal symmetry (8b) of said door (1).

5) Steel-reinforced door, as claimed in claim 2, characterised in that said second means designed to allow the opening of said door (1) to the right or the left comprise said hinges (6, 6a, 6b) fitted symmetrically in relation to said axis of horizontal symmetry (8b) of said door (1).

6) Steel-reinforced door, as claimed in claim 2, characterised in that said second means designed to allow the opening of said door (1) to the right or the left comprise a pair of uprights (16), (17) of said frame (2), on both of which the strike plates of lock (8) are fitted and the holes required for the passage of said bolts (9, 9a) and the assembly of said hinges (6, 6a, 6b) are made.

7) Steel-reinforced door of the type comprising a sheet metal framework (4), strengthened with a plurality of metal structural sections (5, 7), to which are fitted a lock (8) and bolts (9), said metal sheet (4) also acting as support for a plurality of mechanisms designed for the operation of said bolts, said steel-reinforced door being mounted on a frame (2) via hinges (6), and closing due to the effect of said bolts which engage with holes made in said frame, characterised in that it includes:
a second metal sheet (10), connected to said sheet metal framework (4) so as to form, with said framework (4), a closed structure suitable to contain said lock (8) and said bolts (9, 9a), and said mechanisms designed to operate said bolts (9, 9a).
connectors for a central bolt (8) fitted at the horizontal axis of symmetry (8b) of said door (1), thus allowing said door (1) to open to the right or the left, said bolts (9, 9a) being fitted symmetrically in relation to said axis of horizontal symmetry (8b) of said door (1);
hinges (6, 6a, 6b) fitted symmetrically in relation to said axis of horizontal symmetry (8b) of said door (1);
a pair of uprights (16), (17) of said frame (2), on both of which the strike plates of lock (8) are fitted and the holes required for the passage of said bolts (9, 9a) and the fitting of said hinges (6, 6a, 6b) are made.
